(19) United States
(12) Patent Application Publication
(10) Pub. No.: US 2006/0125806 A1
(43) Pub. Date: Jun. 15, 2006

(54) Human-activated displacement control appliance for use with computerized device/mechanism

(75) Inventors: Richard M. Voyles, North Oaks, MN (US); Jaewook Bae, St. Paul, MN (US); Eliot C. Estrine, Eden Prairie, MN (US)

Correspondence Address: JEAN M. MACHELEDT, 501 SKYSAIL LANE, SUITE B100, FORT COLLINS, CO, 80525-3133, US

(73) Assignee: The Regents of the University of Minnesota

(21) Appl. No.: 11/237,173

(22) Filed: Sep. 27, 2005

Related U.S. Application Data
(60) Provisional application No. 60/613,932, filed on Sep. 27, 2004.

(51) Int. Cl. G09G 5/00; G09G 5/08

(52) U.S. Cl. 345/184; 345/161

(57) ABSTRACT

A human-activated displacement control appliance for use with a computerized device to move an object—whether massless, such as a cursor/point/icon/etc. on a computerized display, or having mass, such as a vehicle/craft/robot/cart, manned or not. The appliance includes: (a) an electromagnetic (EM) positional detection component comprising a mechanism for generating a static field incorporated within/on a wearable-support, and sensing points incorporated within/on a donable-item; (b) the sensing points adapted for detecting positional changes, when/if any, within the field; (c) a processing unit for producing signals comprising information about the positional changes, for transmission to a receiving unit. The computerized device adapted to, upon receiving the information, direct the object to so move. The wearable-support may be a glove-support, hat-support, headband-support, wrist-support, shoulder-support, chest-support, shoe-support, belt-support, etc. The donable-item may be a sleeve-cuff, wristband, pant-cuff, vest, chest-sling, leg band, shirt-collar, pant-pocket, etc., a gunstock, grip-end of golf club, and other such tools. The mechanism for generating the static field may be a magetostatic field source, a visible light-emitting source, as well as other types. The sensing points may comprise elements of a magnetoresistive nature, visible light detecting element(s), etc.

This application claims priority to pending U.S. provisional patent application No. 60/613,932 filed on 27 Sep. 2004 on behalf of the assignee hereof for applicants.

### BACKGROUND OF THE INVENTION

### Field of the Invention

In general, the present invention relates to devices (joysticks, remote-controls, etc.) that control movement or displacement of an object (whether ‘massless’): (A) pointer, cursor, or other display symbol and/or icon—which, in turn, controls input to a computerized device/mechanism; or (B) one having mass, such as a remote-controlled machine/robot, a manned vehicle (land rover, aircraft, watercraft, construction equipment, wheelchair/automated cart, etc.), an unmanned vehicle or toy, and other such objects intended for movement over a surface or within an environment/space.

More particularly, the invention is directed to a unique human-activated displacement control appliance for use with a computerized device/mechanism. The appliance employs an electromagnetic (EM) positional detection component comprising a mechanism for generating a static EM field (e.g., this mechanism may be incorporated within/on the back of a wearable-support, such as a glove-support, wristband-support, hat-support, headband-support, shoe-support, belt/waist-support, etc.) plus at least two sensing points which are remote (i.e., not hard-wired) to the wearable support. The plurality of sensing points detect relative positional changes within the field (generated by the field-generating mechanism) for processing into signals transmitted (wireless or hard-wired) to control displacement of a point/cursor (e.g., on a display screen) or mass (e.g., robot/vehicle/cart, manned or not, etc.). The static EM field produced by the mechanism on the wearable-support may be a static magnetic field, or that generated by use of a light-emitting source, such as light-emitting diode (LED). Depending upon the field-generating mechanism employed, sensing points are selected to detect motional changes therewithin (e.g., if the field is magetostatic, sensor points may be magneto-resistive elements; if the field is generated by an LED, the sensor points are light elements adapted for sensing positional changes within the LED's static field). Depending on the type of wearable-support used, sensor points are incorporated within or on, a donable-item, e.g., a sleeve-cuff, wristband, pant-cuff, vest, chest-sling, leg band, shirt-collar, pant-pocket, etc, as well as the gunstock of a rifle held by a soldier, the grip-end of a golf club held by a golfer, and other such tools.

Information as to positional changes of the sensing points within the static EM field is processed into signals transmitted (wireless or hard-wired) to control displacement of the object, whether massless—i.e., either a point/cursor/icon (e.g., on a display screen) or a mass (e.g., robot/vehicle/craft/cart, manned or not, etc.).

### General Technological Background Information

Applicant(s)' Earlier Notable Work in Robot Technology.

In earlier published work of one of the applicants, remotely controlled, unmanned, smaller-sized/“miniature” robot devices are described. Details of these robots are further discussed in prior work of at least one of the applicants hereof: (A) 6-page manuscript, Voyles, Richard M., TerminatorBot: A Robot with Dual-Use Arms for Manipulation and Locomotion, in Proceedings of the 2000 IEEE International Conference on Robotics and Automation, v. 1, pp. 61-66 (April 2000)—identified as ATTACHMENT A in applicants' provisional app.; (B) single-page poster copy Voyles, Richard M., TerminatorBot: A Mesoscale Robot for Urban Search and Rescue, (November 2002)—identified as ATTACHMENT B in applicants' provisional app.; (C) 8-page manuscript, Voyles, Richard M., A Mesoscale Mechanism for Adaptive Mobile Manipulation, in Proceedings of the ASME Dynamic Systems and Control Division—2000, DSC-Vol. 69-2 (2000)—identified as ATTACHMENT C in applicants' provisional app. The focus of early design efforts were on novel robot mechanism(s) having flexible mobility with manipulation capabilities for search and rescue, landmark exploration, and so on.

Glossary of Miscellaneous Terms Provided by Way of Background Reference, Only:

Joystick: An input device that consists of a ‘stick’ extending from a base, where movement of the stick from a reference/central position provides both a direction and a quantity that can be used to control pointer/cursor movement or to control movement of an object, such as a vehicle/robot/device (race car, aircraft, toy car, construction equipment component, wheelchair, and so on).

Pointing device: an input device such as a mouse, trackball, or joystick used to manipulate a cursor or pointer on a computer display; any device used to indicate a position, as a mouse is used to point to a position on a screen. Typical pointing devices include a mouse, pen, lightpen, trackball, touchscreen, touch tablet, touchpad, and possible a joystick or cursor keys. In 3D, various pointing devices include the 3D mouse or bat and the dataglove.

Input device: A device used to enter information into a computerized device, such as keyboard/keypad, touch-screen/touch-sensitive display, mouse, joystick, trackballs, track pointers, touchpad/touch-sensitive pad, and so on. Where the computerized device has some sort of display (whether very small or big screen-size), an input device will include capability for the user to move the pointer/cursor by various physical movement, e.g., sliding a finger around on a touchpad, pressing cursor directional keys on a keyboard/keypad, pressing the screen of a touch-sensitive display, moving a free-rotating ‘ball’ of a trackball in a selected direction, moving a pressure-sensitive ‘bump’ of a track pointer in a selected direction, etc.

Wireless. A term used to describe telecommunications in which electromagnetic waves (rather than some form of wire or cabling) carry the signal over part or the entire communication, or transmission path/pathway.

Semiconductor. A substance, usually a solid chemical element or compound, that can conduct electricity under some conditions but not others, making it a good medium for the control of electrical current. Its conductance varies depending upon the current or voltage applied to a control electrode, or on the intensity of irradiation by infrared (IR), visible light, ultraviolet (UV), or X-ray. The specific properties of a semiconductor depend on the impurities, or dopants, added to it. An N-type semiconductor carries current mainly in the form of negatively-charged electrons in a manner similar to the conduction of current in a wire. A P-type semiconductor carries current predominantly as electron deficiencies called ‘holes.’ A hole has a positive electric charge, considered ‘equal and opposite’ the charge on an electron. In a semiconductor material, the flow of holes occurs in a direction opposite to the flow of electrons. The most common semiconductor material is silicon, which is used predominantly for electronic applications (where electrical currents and voltages are the main inputs and outputs). For optoelectronic applications (where light is one of the inputs or outputs) semiconductor materials used include GaAs, InP and GaN. For inorganic LEDs common semiconductor materials used are: InGaN, which emits near-UV, blue and green light; and InGaP, which emits amber and red light.

Semiconductor LED. A light emitting diode (LED) is a small semiconductor device that emits light in one or more wavelengths (colors). A diode is a device with two electrodes through which a current can be passed in only one direction. The diode is attached to an electrical circuit and encased in a plastic, epoxy, resin or ceramic housing. The housing usually consists of some sort of covering over the device as well as some means of attaching the LED to an electrical source. The housing may incorporate one or many LEDs. In terms of size: an LED is ˜1-2 mm, about the size of a grain of sand. When encased in a housing, the finished product can be several mm or more across.

Magnetoresistive (MR). A term used in connection with the technology and classes of materials for which the resistance to electricity is altered when brought within a magnetic field. A wide variety of materials/elements/structures exhibit this property. Magnetoresistive elements/structures are by-and-large made of a current-carrying magnetic material(s) for which resistivity alters in the presence of an external magnetic field. A variety of types of useful ‘sensing technologies’ have been designed utilizing the magnetoresistive nature of MR elements.

Hall Effect sensor technology. By way of background reference only, as depicted in FIGS. 1A-1E and pointed out in the ten sheets of promotional materials entitled “Micronas: Hall Effect Sensor”, printed from www.intermetall.de/ on Aug. 31, 2004, single-sheet background discussion entitled “Micronas: Hall Effect Sensor,” printed from www.intermetall.de/ on Aug. 31, 2004, and four sheets of Applications Information (Application Note 27702A, Allegro MicroSystems, Inc.) regarding Linear Hall-Effect Sensors, 1996, 2002—labeled as ATTACHMENTS D, E, and F in connection with applicants' provisional app.—Hall effect sensors operate on the physical principle of the so-called Hall effect, named after a discoverer, E. H. Hall: Voltage is generated transversely to the current flow direction in an electric conductor (“Hall voltage”), if a magnetic field is applied perpendicularly (i.e., orthogonally) to the conductor. The Hall effect is pronounced in semiconductors; thus Hall elements are often fabricated of semiconductor material (e.g., the Hall element and its evaluation circuitry may be integrated on a single silicon chip using conventional CMOS technology). The Hall affect is depicted by the schematic labeled FIG. 1A: In a semiconductive platelet, the Hall voltage is generated by the effect of an external magnetic field (direction labeled “Magnetic Flux”) acting perpendicularly to the direction of the current. In FIG. 1B, a CMOS Hall sensor is packaged; in operation, the magnetic flux component perpendicular to the chip surface is measured (arrows through the device) and a proportional electrical signal is emitted which is processed within evaluation circuitry on the chip. FIG. 1C simply represents the Hall sensing principle: Output voltage of the sensor element and associated switching state depend on the magnetic flux density through the Hall plate. FIG. 1D categorizes Hall sensors based upon mode of signal processing and signal output; by and large, they are lumped into either Hall switches or linear Hall sensor devices. Magnetic sensors, such as Hall effect sensors, differ from most other detectors (top schematic labeled (A) of FIG. 1E) in that they do not directly measure a physical property of interest. Hall effect sensors (bottom schematic labeled (B) of FIG. 1E), on the other hand, detect changes, or disturbances, in magnetic field(s) that have been created or modified, and from detected changes derive information about parameters such as direction, presence, rotation, angle, or electrical current. The output signal of Hall effect sensors requires signal processing for translation into useful information about the desired parameter.

Giant Magnetoresistive (GMR) Effect technology. By way of further background reference only specifically in connection with GMR, as further pointed out in 2-sheets of background information entitled “The Giant Magnetoresistive Head: . . . ,” printed from www.research.ibm.com/ on Sep. 26, 2004, and 5-sheets of background information entitled “GMR Sensors Data Book, NVE Corporation” printed from www.nve.com/ on Sep. 26, 2004—labeled as ATTACHMENTS H and I in connection with applicants' provisional app.—A key structure in GMR materials is a spacer layer of a non-magnetic metal between two magnetic metals. Magnetic materials tend to align themselves in the same direction. If a spacer layer is thin enough, changing the orientation of one of the magnetic layers can cause the next one to align itself in the same direction. The magnetic alignment of the magnetic layers periodically swing back and forth from being aligned in the same magnetic direction (parallel alignment) to being aligned in opposite magnetic directions (anti-parallel alignment). Overall resistance is relatively low when the layers are in a parallel alignment and relatively high when in anti-parallel alignment.

One simple arrangement is as follows (shown in “The Giant Magnetoresistive Head: . . . ): two magnetic layers are separated by a spacer layer chosen to ensure that the coupling between magnetic layers was weak. A fourth layer comprising a strong antiferromagnet was added to ‘pin’ in one direction, the magnetic orientation of one of the other layers. When a weak magnetic field, such as that from a bit on a hard disk, passes beneath such a structure, the magnetic orientation of the unpinned magnetic layer rotates relative to that of the pinned layer, generating a significant change in electrical resistance due to the GMR effect. This structure was named the “spin valve”.

### SUMMARY OF THE INVENTION

Briefly described, once again, the invention is a human-activated displacement control appliance for use with a computerized device to move an object—whether massless, such as a cursor/point/icon/etc. on a computerized display, or having mass, such as a vehicle/craft/robot/cart, manned or not. The appliance comprises: (a) an electromagnetic (EM) positional detection component comprising a mechanism for generating a static field incorporated within/on a wearable-support, and a plurality of sensing points incorporated within/on a donable-item, the sensing points remote from the field-generating mechanism; (b) the sensing points adapted for detecting positional changes, when/if any, within the field; and (c) a processing unit for producing signals comprising information about the positional changes, for transmission to a receiving unit. The computerized device is preferably adapted to, upon receiving the information, direct the object to so move. The wearable-support may be one of a variety such as a glove-support, a hat-support, a headband-support, a wrist-support, a shoulder-support, a chest-support, a shoe-support, and a belt-support. The donable-item may be one of a variety such as a sleeve-cuff, a wristband, a pant-cuff, a vest, a chest-sling, a leg band, a shirt-collar, a pant-pocket, a gunstock, a grip-end of a golf club, and other such tools. The mechanism for generating the static field may be a magetostatic field source, a visible light-emitting source, and other types of sources adaptable for generating an EM field that can be detected by sensor elements incorporated with/within/on the donable-item. The sensing points may comprise elements of a magnetoresistive nature (such as GMR-type elements or Hall effect-type sensor elements), visible light detecting element(s), and so on. The type of sensing/detecting elements employed will be selected for coupling with the type of field source selected.

The object, as mentioned elsewhere herein, may be of a wide variety of ‘massless’ type-objects, such as a cursor/icon/point/etc. of a computerized display or other screen display, and objects having a mass (as enumerated, herein) or physical size. For example, the object may be a vehicle including cars, aircrafts, carts, wheelchairs, boats, and other such crafts for motional travel through air, through extraterrestrial space, through or atop an air-fluid boundary of an incompressible fluid such as a body of water, oil slick, etc., and/or through, within or over the ground, and a robot such as any device adapted for unmanned motional travel through air, through extraterrestrial space, through or atop an air-fluid boundary of an incompressible fluid such as a body of water, oil slick, etc., and/or through, within or over the ground.

Distinguishable from conventional joysticks and remote-control type devices is the appliance/apparatus and associated system and program code used to employ components to carry out the unique technique of the invention. As one will appreciate, certain of the unique features of the invention, and further unique combinations of these features, as supported and contemplated in the instant technical discussion may provide a variety of advantages; among these include one or more of the following:

(a) Versatility—The invention may be used for controlling movement or displacement of a wide variety of objects (whether massless): (A) pointer, cursor, or other display symbol, icon, etc.—which, in turn, controls input to a computerized device/mechanism; and/or (B) one having mass, such as a remote-controlled machine/robot, a manned vehicle (land rover, aircraft, watercraft, construction equipment, wheelchair/automated cart, etc.), an unmanned vehicle or toy, and other such objects intended for movement over a surface or within an environment/space, maintenance and inspection of large pieces of motive machinery including an emergency power-off, and so on.

(b) Design flexibility—core components of the appliance are adaptable for use with a wide variety of wearable-support(s) (e.g., EM field-generating mechanism may be incorporated within/with/on the back of a wearable-support, such as a glove-support, a hat-support, a headband-support, a wrist-support, a shoulder-support, a chest-support, a shoe-support, a belt-support, etc.,) and donable-items (e.g., depending on the type of wearable-support used, sensor points are incorporated within/or on, a donable-item, e.g., a sleeve-cuff, a wristband, a pant-cuff, a vest, a chest-sling, a leg band, a shirt-collar, a pant-pocket, a gunstock, a grip-end of a golf club, and other such a tools, etc.)—including those currently available, as tailored to incorporate features hereof, as well as specifically-designed supports and items.

### BRIEF DESCRIPTION OF THE FIGURES

For purposes of illustrating the innovative nature plus the flexibility of design and versatility of the technique of the invention the following figures have been included. One can readily appreciate the advantages and the many features that distinguish the instant invention from conventional devices. The figures have been included to communicate background technology (such as, FIGS. 1A-1E, FIGS. 2-3 and FIGS. 4A-4B, each of which are labeled “PRIOR ART”) as well as communicate features of applicants' innovative apparatus/appliance, system and associated technique by way of example, only, and are in no way intended to unduly limit the disclosure hereof.

FIG. 1A schematically represents the well known Hall affect: Hall voltage is generated by the effect of an external magnetic field (“Magnetic Flux”) acting perpendicularly to the direction of the current.

FIG. 1B schematically (in isometric format) represents a Hall sensor packaged in IC/chip-style packaging.

FIG. 1C schematically represents core concept(s) of Hall effect sensing: Output voltage of the sensor element and associated switching state, respectively, depend upon the magnetic flux density through the Hall plate.

FIG. 1D is a chart that categorizes Hall sensors based on mode of signal processing and signal output; they are lumped into either Hall switches or linear Hall sensor devices.

FIG. 1E top schematic labeled (A) depicts classic sensors that directly measure a physical property of interest; whereas Hall effect sensors (bottom schematic labeled (B) of FIG. 1E) typically do not ‘directly’ measure a parameter of interest.

FIGS. 2-3 and 4A-4B are isometric depictions/photos of prior robot designs of at least one applicant hereof, representing just a couple of the variety of types of objects with which an EM positional detection component of the invention may be used to control motion.

FIGS. 5A-5C, as well as associated component-feature schematic FIG. 6, are isometric depictions/photos of a new tethered robot design of at least one applicant hereof—representing another of type of object which may be controlled employing an EM positional detection component (e.g., such as those labeled herethroughout at 100, 200, 202, 400, 500, and schematically at 600 in FIG. 13).

FIGS. 7A-7B are isometric depictions/photos of a human-activated appliance component 100 in the form of a glove-cuff embodiment for use to control displacement of a point or a mass (not shown for simplicity).

FIGS. 8A-8C schematically illustrate functionality of an EM positional detection component 110 comprising a mechanism for generating a static EM field, plus at least two sensing points, remote (i.e., not hard-wired) to the support-glove (or other wearable-support employed by the user).

FIGS. 9-10 are isometric schematics depicting certain features of human-activated appliance components 200, 202 of the invention in the form of a glove-support & sleeve-cuff embodiment for use to control displacement of an object, i.e., either a point (e.g., cursor 250 in FIG. 10, and elsewhere) or mass (e.g., vehicle/robot in FIGS. 9 and 10 at 240, 241, and elsewhere).

FIG. 11-12 are isometric schematics depicting certain features of human-activated appliance components 400, 500 of the invention in the form of a gunstock 505 & glove-support 508 embodiment as well as a grip-end 405 & glove-support 408 for use to control displacement of an object, i.e., whether a mass (e.g., vehicle/robot in FIGS. 11 and 12 at 440, 441, 540, and elsewhere), or a point (e.g., cursor 250 in FIG. 10, and elsewhere).

FIG. 13 is a high-level chart depicting certain core, as well as additional, features of an appliance; as one can appreciate there are alternative operable combinations thereof.

### ADDITIONAL DESCRIPTION DETAILING FEATURES OF THE INVENTION

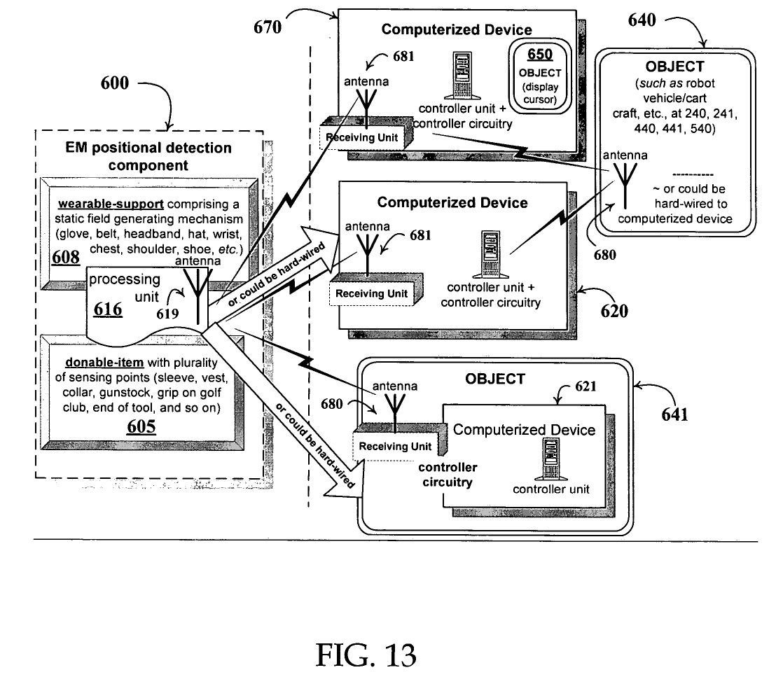

By viewing the figures and associated representative structure embodiments, one can further appreciate the unique nature of core as well as additional and alternative features of the appliance/apparatus and associated system. Reference will be made to various features—especially as depicted in the schematic labeled FIG. 13—by way of association to respective figures.

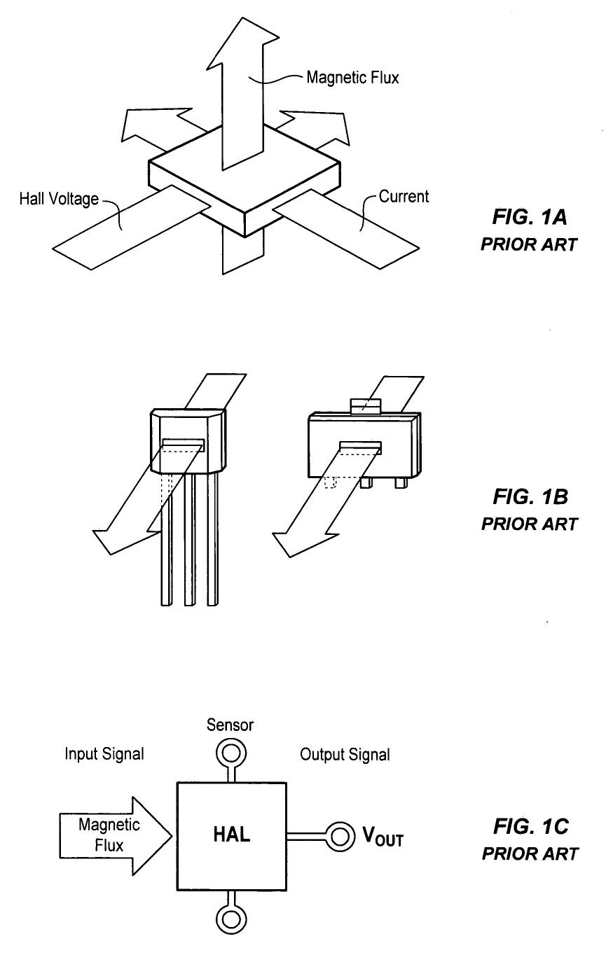

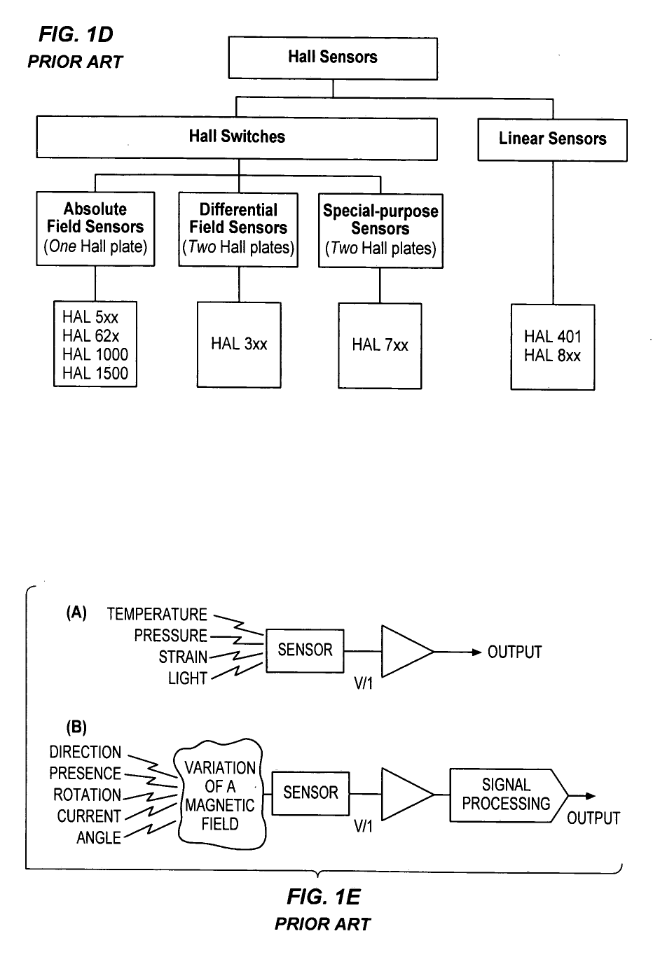

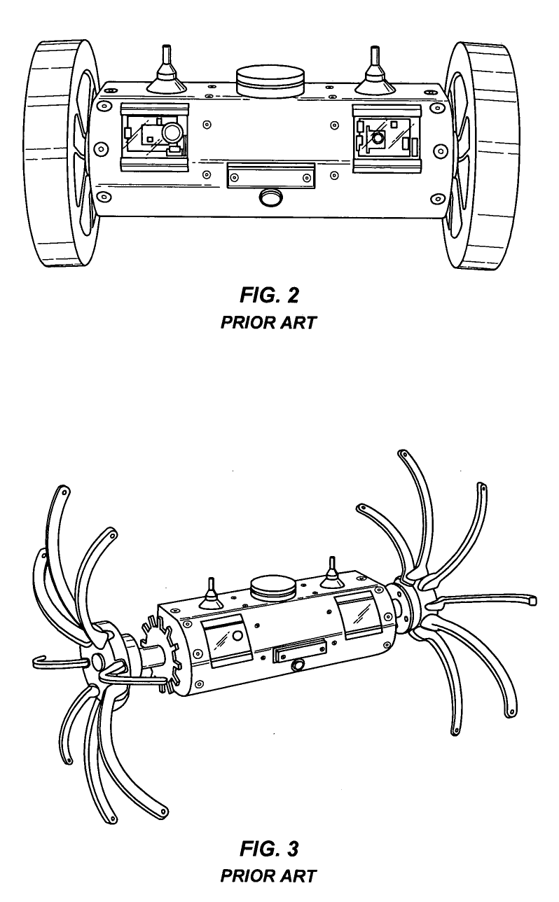

Also discussed above, FIG. 1A schematically represents the well known Hall affect: Hall voltage is generated by the effect of an external magnetic field (“Magnetic Flux”) acting perpendicularly to the direction of the current. FIG. 1B schematically (in isometric format) represents a Hall sensor packaged in IC/chip-style packaging. FIG. 1C schematically represents core concept(s) of Hall effect sensing: Output voltage of the sensor element and associated switching state, respectively, depend upon the magnetic flux density through the Hall plate. FIG. 1D is a chart that categorizes a line of Hall sensors (identification numbers reference arbitrary part numbers) based on mode of signal processing and signal output; they are lumped into either Hall switches or linear Hall sensor devices. FIG. 1E top schematic labeled (A) depicts classic sensors that directly measure a physical property of interest; whereas Hall effect sensors (bottom schematic labeled (B) of FIG. 1E) typically do not ‘directly’ measure a parameter of interest.

FIGS. 2-3 and 4A-4B are isometric depictions/photos of smallish sized prior robot designs of at least one applicant hereof, used in search and rescue, surveying/surveillance, etc.; representing just a couple of the variety of types of objects with which an EM positional detection component of the invention may be used to control motion. As explained above, details of these robots are further discussed in prior work of at least one of the applicants hereof: (A) 6-page manuscript, Voyles (April 2000); (B) single-page poster copy Voyles (November 2002); (C) 8-page manuscript, Voyles, ASME (2000).

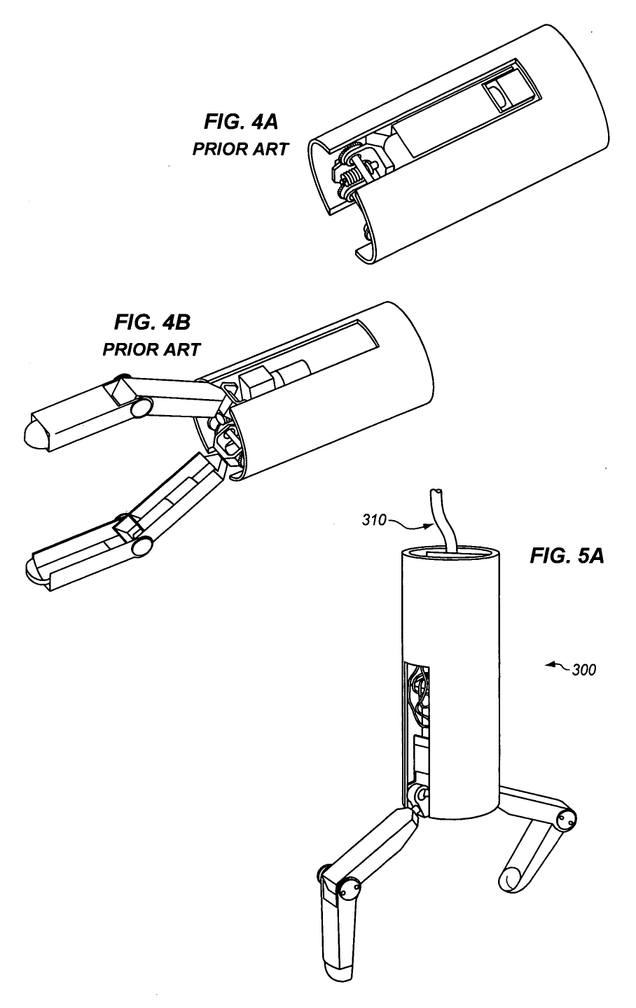

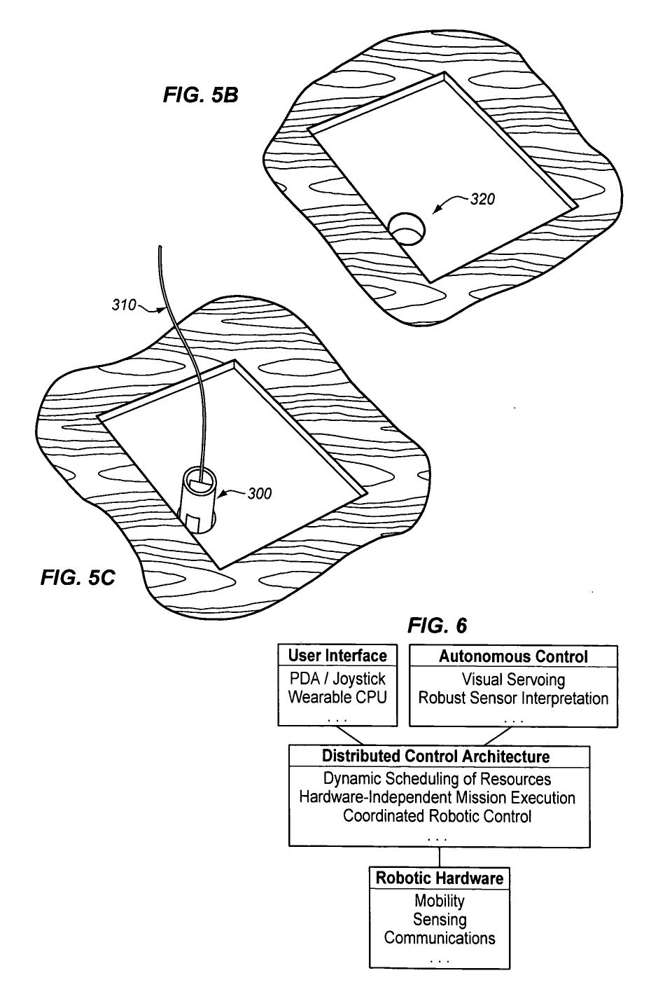

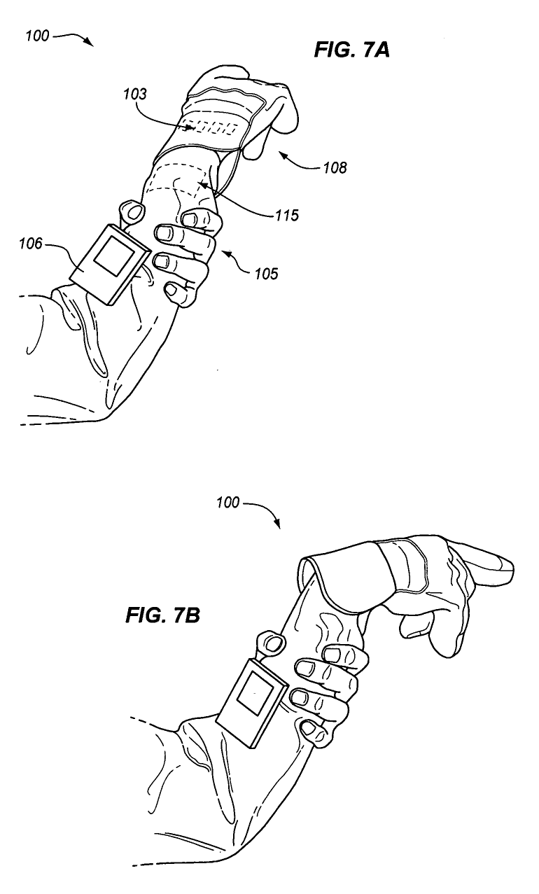

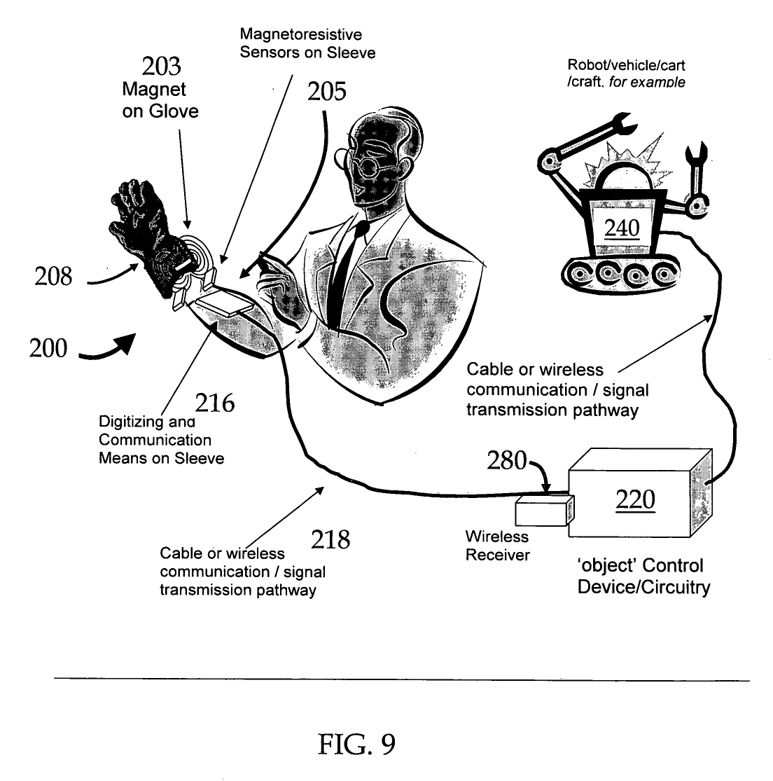

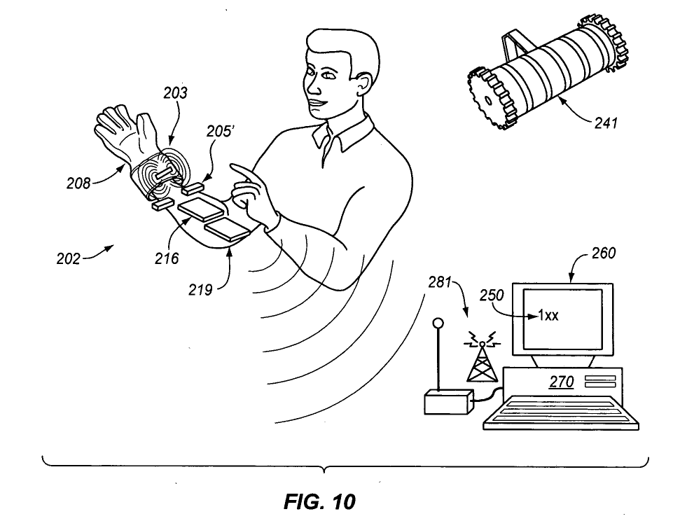

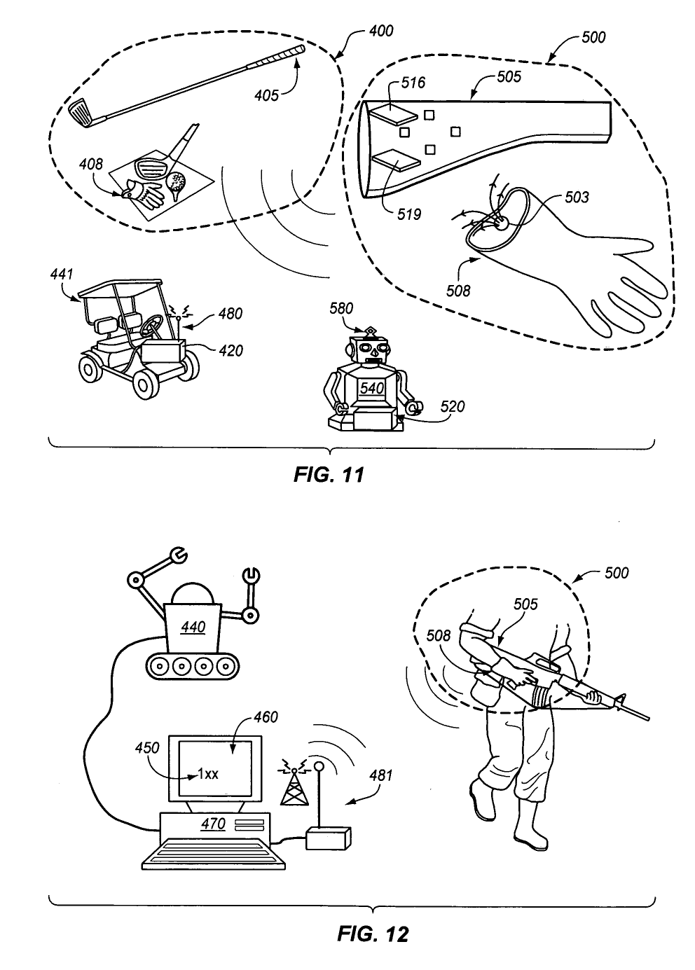

FIGS. 5A-5C, as well as associated component-feature schematic FIG. 6, depict a new tethered robot design of at least one applicant hereof—a ‘CRAWLER’ Scout robot with vision capabilities—preferably for use in search and rescue, surveying/surveillance, etc.—representing another of type of object. Shown in FIGS. 5A and 5C is a soda can sized robot 300 with dual-use limbs for locomotion as well as manipulation, with which an EM positional detection component (such as those depicted at 100, 200, 202, 400, 500, 600 herethroughout) may be used to control motion. Note that the robot-objects of FIGS. 5A and 5C remain connected by way of a tether 310 available for use to retrieve the robot after performing a site investigation, but also to provide cabling for power and communications to and from the robot while investigating a ‘bore hole’ (FIG. 5A) site. FIGS. 5A, 5C depict a tethered robot object 300 which can be fed through the bore (FIG. 5B at 320) for “core-bored” search and rescue applications. Robot-objects such as those depicted in FIGS. 4A-4B and 3 are also suitable for core-bored applications as the appendages of these robots can be tucked inside an outer housing/shell (e.g., FIG. 4A which has a cylindrical outer housing) and extended for movement once at a destination. Control of such movement/displacement within and around a site, can be done employing an EM positional detection component (e.g., such as those labeled 100 in FIGS. 7A-7B; 200, 202, respectively identified in FIGS. 9 and 10; 400, 500, respectively identified in FIGS. 11 and 12; or schematically at 600 in FIG. 13).

FIGS. 7A-7B depict human-activated appliance component 100 in the form of a glove-cuff embodiment for use to control displacement of a point or a mass (not shown for simplicity). An EM positional detection component 100 has a magnet 103 for generating a static field incorporated within/on a wearable-support (shown here as a glove, by way of example, only). At least two sensing points are incorporated within/on a donable-item (shown here as a sleeve-cuff, by way of example, only): The sensing points located remotely from the magnet mechanism 103. These sensing points are adapted for detecting positional changes, when/if any, within the field generated. A processing unit (e.g., at 106 in FIGS. 7A-7B, and shown in FIGS. 9-13 at 216, 516, 616) is employed for producing signals comprising information about the positional changes, for transmission to a receiving unit (not shown here for simplicity). A computerized device (e.g., shown in FIGS. 9-13 at 220, 270, 420, 520, 470, 620, 621, and 670, by way of example) is employed to, upon receiving information from the processing unit, direct the object to move. A suitable processing unit, such as may be located within a PDA (personal desk assistant, or other such personal computer, PC, of a wide variety of sizes and footprints) shown by way of example in FIGS. 7A-7B at 106, is preferably in proximity to the donable-item. The processing unit—whether within a PC or otherwise packaged within a unit—may be incorporated with sleeve-cuff 105, e.g., sewn or otherwise stitched within layers of, secured to a top layer, held in place with an armband, and so on.

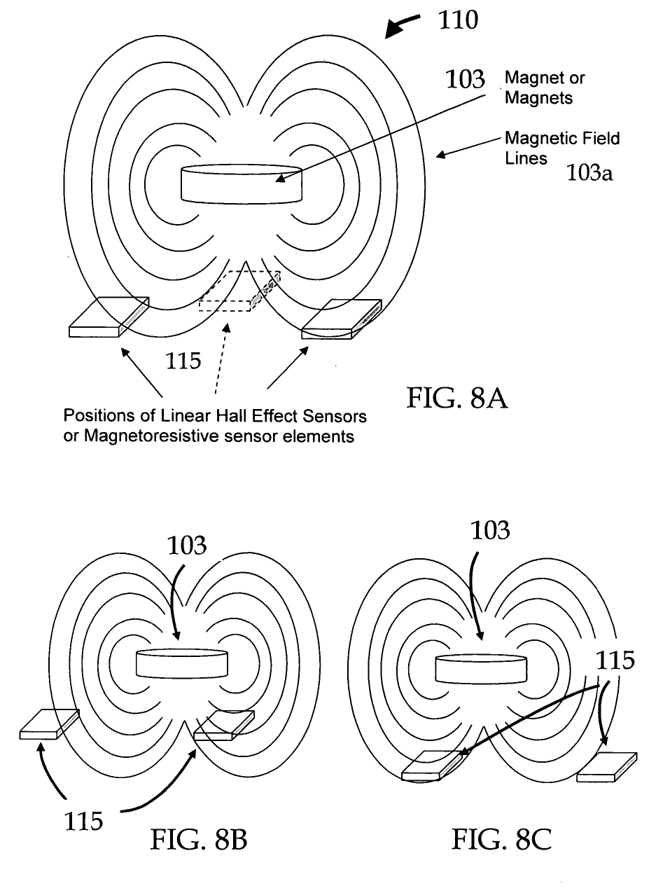

FIGS. 8A-8C schematically illustrate functionality of an EM positional detection component 110 comprising a mechanism 103 for generating a static EM field 103a (e.g., the mechanism may be incorporated with/within/on the back of the support-glove in FIGS. 7A-7B, and 9-12) plus at least two sensing points/elements 115, remote (i.e., not hard-wired) to the support-glove (or other support worn or otherwise employed by the user). The plurality of sensing points 115 detect relative positional changes within the field generated by the field-generating mechanism, for processing into signals transmitted (wireless or hard-wired) to control displacement of an object, whether massless—either a point/cursor/icon (e.g., on a display screen) or a mass (e.g., robot/vehicle/craft/cart, manned or not, etc.) and so on, as explained herein.

FIGS. 9-10 are isometric schematics depicting certain features of human-activated appliance components shown at 200, 202 in the form of a glove-support 208 & sleeve-cuff 205 embodiment for use to control displacement of an object, i.e., either a point (e.g., cursor 250 in FIG. 10, and elsewhere at 450, 650 on a respective display 260, 460) or mass (e.g., vehicle/robot in FIGS. 9 and 10 at 240, 241, and elsewhere labeled 440, 441, 540, 640, 641). Elements (e.g., 115 in FIGS. 8A-8C, which can be linear Hall Effect sensor elements, GMR elements, or other such elements, visible light detecting elements, and so on) associated with the sleeve-cuff 205 operate with an associated static field generating mechanism 203 (e.g., magetostatic field source, visible light-emitting source, and so on) associated with the glove-support 208. Digitization and/or other processing of information regarding desired movement can be done on-site (unit 216) at the sleeve-cuff 205 and transmitted (218m 219 via hardwiring and/or wireless transmission) to suitable receiving unit 280, 281 to move the object 240, 250 on display 260, 241. The user may wish to first move cursor-object 250 to engage/click-on active display screen prompts, for example, preprogrammed to, in turn, direct(s) movement/motion of a second object such as the robot, vehicle, etc., such as is depicted at 240, 241, (and elsewhere at 440, 441, 540).

FIG. 11-12 are isometric schematics depicting certain features of human-activated appliance components 400, 500 of the invention in the form of a gunstock 505 & glove-support 508 embodiment as well as a grip-end 405 & glove-support 408 for use to control displacement of an object, i.e., whether a mass (e.g., vehicle/robot in FIGS. 11 and 12 at 440, 441, 540, and elsewhere at 240, 241, 640, 641), or a point (e.g., cursor 250 in FIG. 10, and elsewhere labeled 450, 650 on a respective display 260, 460). Elements and processing unit 516 as well as a transmission unit 519 are associated with gunstock 505; likewise, though detail is not provided in FIG. 11, grip-end 405, and other such end-portions of tools (esp. those that operate from a distance) held by a user, will also accommodate elements, information processing capabilities 516, and transmission capabilities 519—whether done in a wireless manner, or using couplings for hardwiring processing unit to a computerized device (such as 470, and elsewhere at 620, 621, 670). In the case where the object is a wheelchair, or other object within which a user is located, the user may employ a glove-support (208, 508, 408), upper-arm-support, shoulder-support, chest-support, etc., operationally with the end portion of the arm of the wheelchair (not shown), comprising components of functionality similar to the gunstock 505 or grip end 405, to move the wheelchair.

In summary fashion, FIG. 13 provides a high-level depiction of certain core, as well as additional, features of an appliance of the invention. As one can appreciate, there are alternative operable combinations thereof: the computerized device (e.g., 220, 270 in FIGS. 9-10, and elsewhere at 420, 520, 470, 620, 621, 670) in concert with signal receiving unit (e.g., 280, 281 in FIGS. 9-10, and elsewhere at 480, 481, 580, 680, 681) and associated controller circuitry are configured in a manner that is suitable for carrying out functionality of the human-activated displacement control appliance. The EM positional detection component 600 may be operated in a wide variety of suitable environments, including those shown. The specific configuration of the donable-item 605 and wearable-support 608 pair employed is preferably targeted at intended environment in which the appliance is used, as well the type of object (e.g., 640, 641).

Concerning further alternate configurations, one can appreciate that: The computerized device may comprise a controller unit as well as controller circuitry adapted for further processing of signals transmitted from the processing unit; the computerized device may be located in proximity with a housing for the object; the receiving unit may comprise a wireless transmitter for communication with the processing unit; the computerized device may comprise a controller unit located remotely from a housing for the object; the receiving unit may comprise the controller circuitry for further processing of signals transmitted from the processing unit; the receiving unit may comprise a wireless transmitter for communication with the object; the receiving unit may comprises a wireless EM receiver in communication with controller circuitry for further processing the signals transmitted from the processing unit; the personal computer may comprise a wireless transmitter for communication with a second object; and a second receiving unit in communication with the second object can be employed to, upon receiving information from a wireless transmitter, direct the second object to move.

Once again, each enclosure that was identified and labeled an ATTACHMENT, and filed with applicants' above-identified provisional application, is hereby incorporated by reference, herein, for purposes of providing information concerning background technology; by way of reference only, here, each listed ATTACHMENT was described in applicants' provisional application as follows:

ATTACHMENT A is a 6-page manuscript: Voyles, Richard M., TerminatorBot: A Robot with Dual-Use Arms for Manipulation and Locomotion, in Proceedings of the 2000 IEEE International Conference on Robotics and Automation, v. 1, pp. 61-66 (April 2000).

ATTACHMENT B is a single-page poster copy Voyles, Richard M., TerminatorBot: A Mesoscale Robot for Urban Search and Rescue, (November 2002).

ATTACHMENT C is a 8-page manuscript: Voyles, Richard M., A Mesoscale Mechanism for Adaptive Mobile Manipulation, in Proceedings of the ASME Dynamic Systems and Control Division—2000, DSC-Vol. 69-2 (2000).

ATTACHMENT D ten sheets of promotional materials Micronas: Hall Effect Sensor, printed from www.intermetall.de/products/overview/sensors/index.php on Aug. 31, 2004 included herewith for its general technical discussion and background information regarding the design and operation of magnetic Hall effect sensors.

ATTACHMENT E single-sheet background discussion Micronas: Hall Effect Sensor, printed from www.intermetall.de/products/overview/sensors/details/sensor7.php on Aug. 31, 2004 included herewith for its general technical discussion and background information regarding Industrial application—position measurement, Hall effect sensors.

ATTACHMENT F includes four sheets of Applications Information (Application Note 27702A, Allegro MicroSystems, Inc.) regarding Linear Hall-Effect Sensors, 1996, 2002 included herewith for its general technical discussion and background information regarding operation of magnetic Hall effect sensors.

ATTACHMENT G 2-sheet background discussion Light-emitting diodes, printed from www.allaboutcircuits.com/vol_{—}3/chpt_{—}3/12.html on Sep. 24, 2004 included herewith for its general technical discussion and background information regarding principles and applications of light-emitting diodes, or LED's.

ATTACHMENT H 2-sheets of background information entitled The Giant Magnetoresistive Head: . . . , printed from www.research.ibm.com/research/gmr.html on Sep. 26, 2004 included herewith for its general technical discussion and background information regarding principles and applications of GMR technology.

ATTACHMENT I 5-sheets of background information entitled GMR Sensors Data Book, NVE Corporation printed from www.nve.com/spec/PDFs/catalog.pdf on Sep. 26, 2004 included herewith for its general technical discussion regarding GMR sensor technology.

### EXAMPLE 1

In connection with the tethered robot technology shown in FIGS. 5A-5C, for example, a gloved-cuff user control interface component (such as that depicted in FIGS. 7A-7B at 100 and FIGS. 9-10 at 200, 202, respectively, and 400, 500 in FIGS. 11-12) is employed for controlling the robot (240, 241, 440, 540). The intercommunication between the appliance interface component (100, 200, 202, 400, 500) and the object may be by way of wireless transmission and/or via cabling/hard-wired. Search and rescue operations take place under dangerous conditions that require extraordinary safety measures for emergency response personnel. Depending upon the type and level of known or potential contamination, many types of protective gear are required for all on-site operators. Conventionally, protective clothing/gear requirements include: gloves/hand protection, safety boots/foot protection, safety goggles/eye protection, a respirator/clean air supply, and long sleeves and pants/limb protection. In most cases, only certain types of protective gear (gloves, boots; goggles, etc.) that meet rigorous specifications are approved for on-site use.

While many of these protective devices may seem like annoyances to a user that limit mobility, dexterity, and the senses, gloves are often cited as the most encumbering. Gloves limit both the dexterity of the hand as well as its tactile sense, making many fine manipulation tasks difficult. Interacting with a computer keyboard is particularly difficult.

The dangerous conditions under which Search and Rescue crew work make the cartage of equipment difficult. Uneven surfaces, unstable footing, and low-hanging obstructions cause imbalance that challenges bipedal locomotion. Emergency responders often use their hands and arms to steady and balance themselves so they prefer to have their hands free. The weight of additional equipment contributes to these types of imbalance and unsteadiness.

In operation, the appliance/apparatus of the invention first generates a ‘localized’ static EM field (103a FIG. 8A) fixed with respect to a coordinate system established for the cuff of the glove (for example, at 208, 408, 508). The static EM field can be generated by a variety of means (103, 203, 503) including a permanent magnet or a light emitting device (such as a light emitting diode or light bulb—both of which provide EM radiation/emissions in the visible spectrum). As a user's wrist is twisted around two or three axes, the static field around the glove-cuff moves with respect to the forearm. The intensity of the EM field generated is measured at multiple, at least two or more, locations around the forearm by sensors embedded in/on the sleeve. The sensor elements incorporated within/on the sleeve-cuff are wired to amplification and digitization circuitry which can then either be directly hard-wired to a control device (such as a personal computer, PC, shown as a personal data assistant, PDA) or in communication with a wireless transmission module that relays the wrist position data to a receiver attached to a remote-control device, or the like.

The use of field emitting and field detecting devices eliminates the requirement for wires/physical connection between the wearable-support (such as a glove) and the donable-item (cuff on a sleeve or, simply, the sleeve itself). This permits the wearable-support (here, for example, a glove) to be removed without encumbrance, as well as to be shared with other users wearing similar donable-items (sleeve) devices. The use of one or more permanent-type magnets, and field detection sensor elements eliminates the requirement for a bulky external source of power, such as a battery or solar cell, to the glove. While the use of visible-light emitting devices (LED's, for example) and visible light sensors requires a power source (such as a solar cell, or battery, or other form of chemical reaction) to produce illumination at the glove to be measured at the sleeve—the overall power requirements for such a source is relatively small. For the use of light emitting diodes (LEDs), a button battery could power the LEDs and a modulating source to reduce the effects of background illumination.

As shown schematically in FIG. 8A, preferably two or more sensor elements detect the strength of the static field at distinct points. Additional sensor elements may be incorporated into the donable-item to detect additional axes permitting a more-robust field measurement(s). As schematically depicted in FIGS. 8B and 8C, movement of the glove (or other wearable-support for the field generating mechanism, i.e., the field source) causes movement of the static field generating mechanism itself, which in-turn causes altered field strengths to be measured at the sensing sites/points: ‘altered’ being in reference to that which was measured during an initial calibration of the appliance. Triangulation algorithms suitably estimate the motion of the field due to the disturbance caused by moving the field source by way of the user moving the glove/wearable-support with respect to the sensors on the sleeve. Suitable conventional techniques may be utilized to incorporate the field generating mechanism within/on the wearable-support therefor and to incorporate the sensing points within/on the donable-item (a non-exhaustive listing for each of the support and item have been provided, by way of example, elsewhere herein). For example, if the elements are magnetoresistive (e.g., GMR type) elements, the magnetic material may be applied by using a ‘sputtering’ technique to an outer layer, or a layer sandwiched between a liner and a weather-resistant outer layer. LED's sensing elements may be packaged and woven into the donable-item. The EM field generating mechanism may likewise be woven in-between a liner and outer-protective, weather resistant layer. In the case of visible light, the EM field generated will have to be ‘viewable’ by the visible light sensor elements.

Means is provided to indicate to the controlled device when appliance signals are relevant for the control task being carried out by a user. This can be a manual switch or button that instructs the communicating mechanism to enable or disable commands.

Where the fields generated—and in operation, are ‘in motion’—are non-linear, linearization and translation of measurements taken is necessary to produce accurate estimates of the motion of the magnetic field with respect to the sleeve. This may be done by way of providing access to look-up tables or an approximation algorithm of the non-linear function, and so on. The sleeve can be rigid with respect to the forearm to reduce de-calibration of the appliance during field use. Where the sleeve garment/material is not substantially rigid with respect to the forearm, or the glove cuff is substantially non-rigid, periodic re-calibration may be necessary. This can be done manually by having the user move the glove in a prescribed pattern during a calibration phase ‘run’ at the initiation of each command session. Another re-calibration approach is to collect data over periods of use to ‘learn’ patterns of de-calibration, permitting derivation of an inverse of any de-calibration effect found, so that translation induced by de-calibration may, thereafter, automatically be removed.

By way of example, and as depicted in FIGS. 9 and 10, two applications of an appliance of the invention—as a mobile robot control and as a massless cursor/pointer control—are further described: The first application (see FIG. 9) employs a magnet on a glove-support 208 and magnetoresistive sensors on the sleeve 205. The sleeve also contains an amplifier, circuitry for digitizing and serialization (e.g., at 216), and a communication pathway 216/219 (e.g., cabling or wireless communication apparatus and associated circuitry), to communicate information processed at the sleeve to a remote control device. The user can remotely ‘teleoperate’ the robot by moving his/her wrist in a manner whereby the hand operates to perform ‘joystick’-type functionalities. Preferably at least two sensor elements are used with the field generating mechanism to provide two axes of command: Tilt the wrist forward, the robot (240) moves forward; tilt the wrist backward, the robot moves backward; Tilt the wrist to the right, the robot moves right; and likewise for left. A second example (see FIG. 10) application employs more wireless transmission capabilities 219, 281, and the controller unit 220 is replaced by a personal computer (PC) shown at 270. The digitizing and communication circuitry may be electrically connected to a Bluetooth radio module that communicates with the PC. The apparatus 202 remotely controls the computer's cursor/pointer 250 on display 260 (e.g., as a replacement for a mouse user interface/input device). Tilt the wrist to the left, the cursor moves to the left. Tilt the wrist forward, the cursor moves up, and so on.

The appliance of the invention (e.g., FIGS. 7A-7B, and 9-13) may be used to remotely control a variety of devices (including PCs 270, 470, 670 robots 240, 241, 440, 441 video games, wheelchairs, construction equipment, etc.). While depicted in FIGS. 7A-7B, 9-10 as a glove-sleeve pair, as mentioned, the appliance of the invention may be applied to other suitable wearable-support and donable-item pairs of articles of clothing, such as a hat-collar arrangement could be used to control the wheelchair of a paraplegic, a shoe-pant cuff arrangement could be used to control a dance-oriented video game, and so on.

As one will appreciate, the appliance/apparatus of the invention is handy to use, does not require additional bulky components/pieces of equipment to be carted/carried around by the user ‘on-site’, whether at a game arcade, search & rescue site, home-office, wheelchair, archeological dig site, backyard, research lab, etc. Once the appliance is calibrated (which can be done in a self-calibration mode), operation takes relatively minimal training. Complex ‘remote-control’ features may be incorporated/programmed into a portable processing unit worn by the user that controls a variety of complex displacement/motions for the object. A feature-specific switch on-and-off may be incorporated and readily accessible, as well as a hibernate-mode for conserving power resources on-site.

While certain representative embodiments and details have been shown for the purpose of illustrating features of the invention, those skilled in the art will readily appreciate that various modifications, whether specifically or expressly identified herein, may be made to these representative embodiments without departing from the novel core teachings or scope of this technical disclosure. Accordingly, all such modifications are intended to be included within the scope of the claims. Although the commonly employed preamble phrase “comprising the steps of” may be used herein, or hereafter, in a method claim, the Applicants do not intend to invoke 35 U.S.C. §112 [symbol] 6 in a manner that unduly limits rights to its innovation. Furthermore, in any claim that is filed herewith or hereafter, any means-plus-function clauses used, or later found to be present, are intended to cover at least all structure(s) described herein as performing the recited function and not only structural equivalents but also equivalent structures.

We claim:

1. A human-activated displacement control appliance for use with a computerized device to move an object, the appliance comprising:
(a) an electromagnetic (EM) positional detection component comprising a mechanism for generating a static field incorporated within a wearable-support, and a plurality of sensing points incorporated within a donable-item, the sensing points remote from the field-generating mechanism;
(b) the sensing points adapted for detecting positional changes within the field;
(c) a processing unit for producing signals comprising information about the positional changes, for transmission to a receiving unit; and
(d) the computerized device adapted to, upon receiving the information, direct the object to so move.

2. The appliance of claim 1 wherein:
(a) the wearable-support is selected from the group consisting of a glove-support, a hat-support, a headband-support, a wrist-support, a shoulder-support, a chest-support, a shoe-support, and a belt-support;
(b) the mechanism for generating the static field is selected from the group consisting of a magetostatic field source and a visible light-emitting source; and
(c) the object is selected from the group consisting of a cursor of a display, a vehicle, and a robot.

3. The appliance of claim 1 wherein:
(a) the donable-item is selected from the group consisting of a sleeve-cuff, a wristband, a pant-cuff, a vest, a chest-sling, a leg band, a shirt-collar, a pant-pocket, a gunstock, a grip-end of a golf club, and a tool end-portion;
(b) the mechanism for generating the static field is selected from the group consisting of a magetostatic field source and a visible light-emitting source; and
(c) the object is selected from the group consisting of a cursor of a display, a vehicle, and a robot.

4. The appliance of claim 1 wherein:
(a) the mechanism for generating the static field comprises a magetostatic field source;
(b) each sensing point comprises a magnetoresistive element; and
(c) the computerized device comprises a personal computer and the object is a cursor of a display.

5. The appliance of claim 1 wherein:
(a) the mechanism for generating the static field comprises a magetostatic field source;
(b) each sensing point comprises a magnetoresistive element; and
(c) the computerized device comprises a controller unit located in proximity with a housing for the object having been selected from the group consisting of a vehicle and a robot.

6. The appliance of claim 1 wherein:
(a) the processing unit is incorporated with the donable-item;
(b) the computerized device, located in proximity with a housing for the object, comprises a controller unit and controller circuitry adapted for further processing of the signals transmitted from the processing unit;
(c) the receiving unit comprises a wireless transmitter for communication with the processing unit; and
(d) the object having been selected from the group consisting of a vehicle and a robot.

7. The appliance of claim 1 wherein:
(a) the processing unit is in proximity to the donable-item;
(b) the receiving unit is in electrical communication with the processing unit;
(c) the computerized device comprises a controller unit located remotely from a housing for the object having been selected from the group consisting of a vehicle and a robot.

8. The appliance of claim 1 wherein:
(a) the mechanism for generating the static field comprises a visible light-emitting source;
(b) each sensing point comprises a visible light detecting element; and
(c) the computerized device comprises a personal computer and the object is a cursor of a display.

9. The appliance of claim 1 wherein:
(a) the mechanism for generating the static field comprises a visible light-emitting source;
(b) each sensing point comprises a visible light detecting element; and
(c) the computerized device comprises a controller unit located in proximity with a housing for the object having been selected from the group consisting of a vehicle and a robot.

10. The appliance of claim 1 wherein:
(a) the processing unit is in proximity to the donable-item;
(b) the receiving unit comprises controller circuitry for further processing the signals transmitted from the processing unit; and
(c) the controller circuitry is in electrical communication with the object having been selected from the group consisting of a vehicle and a robot.

11. The appliance of claim 1 wherein:
(a) the donable-item is selected from the group consisting of a sleeve-cuff, a wristband, a pant-cuff, a vest, a chest-sling, a leg band, a shirt-collar, a pant-pocket, a gunstock, a grip-end of a golf club, and a tool end-portion;
(b) the processing unit is incorporated with the donable-item;
(c) the computerized device comprises controller circuitry for further processing the signals transmitted from the processing unit; and
(d) the receiving unit comprises a wireless transmitter for communication with the object selected from the group consisting of a vehicle and a robot.

12. The appliance of claim 1 wherein:
(a) the processing unit is in proximity to the donable-item;
(b) the receiving unit comprises a wireless EM receiver in communication with controller circuitry for further processing the signals transmitted from the processing unit;
(c) the controller circuitry is within the computerized device comprising a personal computer; and
(d) the object is a cursor of a display for the personal computer.

13. The appliance of claim 12 wherein:
(a) the donable-item is selected from the group consisting of a sleeve-cuff, a wristband, a pant-cuff, a vest, a chest-sling, a leg band, a shirt-collar, a pant-pocket, a gunstock, a grip-end of a golf club, and a tool end-portion;
(b) the processing unit is incorporated with the donable-item;
(c) the personal computer comprises a wireless transmitter for communication with a second object selected from the group consisting of a vehicle and a robot; and
(d) a second receiving unit in communication with the second object adapted to, upon receiving information from the wireless transmitter, direct the second object to move.

14. The appliance of claim 1 wherein:
(a) the wearable-support is selected from the group consisting of a glove-support, a hat-support, a headband-support, a wrist-support, a shoulder-support, a chest-support, a shoe-support, and a belt-support;
(b) the receiving unit comprises a wireless EM receiver in communication with controller circuitry for further processing the signals transmitted from the processing unit;
(c) the controller circuitry is adapted for directing wireless electrical communication with the object; and
(d) the object is selected from the group consisting of a cursor of a display, a vehicle, and a robot.

15. A human-activated displacement control appliance for use with a computerized device to move an object, the appliance comprising:
(a) a magnetostatic positional detection component comprising a mechanism for generating a static magnetic field incorporated within a wearable-support, and a plurality of magetoresistive sensing elements incorporated within a donable-item, the sensing elements remote from the static field-generating mechanism;
(b) the donable-item is selected from the group consisting of a sleeve-cuff, a wristband, a pant-cuff, a vest, a chest-sling, a leg band, a shirt-collar, a pant-pocket, a gunstock, a grip-end of a golf club, and a tool end-portion;
(c) the sensing elements adapted for detecting positional changes within the magnetic field; and
(d) the computerized device adapted to, upon receiving information about a positional change within the magnetic field, direct the object to so move.

16. The appliance of claim 15 wherein the magetoresistive sensing elements are selected from the group consisting of GMR type elements and Hall effect type elements.

17. The appliance of claim 15 wherein:
(a) the wearable-support is selected from the group consisting of a glove-support, a hat-support, a headband-support, a wrist-support, a shoulder-support, a chest-support, a shoe-support, and a belt-support;
(b) the receiving unit comprises a wireless EM receiver in communication with controller circuitry for further processing the signals transmitted from the processing unit; and
(c) the object is selected from the group consisting of a cursor of a display, a vehicle, and a robot.

18. The appliance of claim 15 wherein:
(a) the receiving unit comprises a wireless EM receiver in communication with controller circuitry for further processing the signals transmitted from the processing unit;
(b) the controller circuitry is within the computerized device comprising a personal computer;
(c) the object is a cursor of a display for the personal computer;
(d) the personal computer comprises a wireless transmitter for communication with a second object; and
(e) a second receiving unit in communication with the second object adapted to, upon receiving information from the wireless transmitter, direct the second object to move.

19. A human-activated displacement control appliance for use with a computerized device to move an object, the appliance comprising:
(a) an electromagnetic (EM) positional detection component comprising a visible light-emitting mechanism for generating a field incorporated within a wearable-support, and a plurality of visible light detecting elements incorporated within a donable-item, the sensing elements remote from the visible light field generating mechanism;
(b) the donable-item is selected from the group consisting of a sleeve-cuff, a wristband, a pant-cuff, a vest, a chest-sling, a leg band, a shirt-collar, a pant-pocket, a gunstock, a grip-end of a golf club, and a tool end-portion;
(c) the sensing elements adapted for detecting positional changes within the magnetic field; and
(d) the computerized device adapted to, upon receiving information about a positional change within the magnetic field, direct the object to so move.

20. The appliance of claim 19 wherein:
(a) the wearable-support is selected from the group consisting of a glove-support, a hat-support, a headband-support, a wrist-support, a shoulder-support, a chest-support, a shoe-support, and a belt-support; and
(b) the object is selected from the group consisting of a cursor of a display, a vehicle, and a robot.
